(19) United States
(12) Patent Application Publication
(10) Pub. No.: US 2006/0188625 A1
(43) Pub. Date: Aug. 24, 2006

(54) Method to improve taste of food or beverage with a reduced amount of total fat by addition of yeast extract and food or beverage thereof

(76) Inventors: Jan Gerrit Kortes, Leusden (NL); Bertus Noordam, 's-Gravenzande (NL)

Correspondence Address: NIXON & VANDERHYE, PC, 901 NORTH GLEBE ROAD, 11TH FLOOR, ARLINGTON, VA, 22203, US

(21) Appl. No.: 10/563,320

(22) PCT Filed: Jul. 12, 2004
(86) PCT No.: PCT/EP04/07837

§ 371 Date: Jan. 4, 2006

(51) Int. Cl. A23L 1/22

(52) U.S. Cl. 426/534

(57) ABSTRACT

The present invention discloses a method for improving the fat note in the taste and/or in the aroma and/or in the mouthfeel of a food with a reduced amount of fat by addition to the food of a yeast extract comprising free amino acids and at least 8% w/w of 5′-ribonucleotides. Preferably a yeast extract having a ratio of at most 3.5 between the percentage (w/w) of free amino acids and the percentage (w/w) of the total amount of 5′-GMP and 5′-IMP is used. Preferably, a yeast extract having a ratio of at most 12 between the percentage (w/w) of protein and the percentage (w/w) of the total amount of 5′-GMP and 5′-IMP is used. The invention also discloses a food with a reduced amount of fat with an improved fat note in the taste and/or in the aroma and/or in the mouthfeel.

### FIELD OF THE INVENTION

This invention relates to a method for improving the fat note in the taste and/or in the aroma and/or in the mouthfeel of food with a reduced amount of fat by addition of a yeast extract to the food. Further the invention relates to food with a reduced amount of fat with an improved fat note in the taste and/or in the aroma and/or in the mouthfeel.

Fats or lipids, as well as carbohydrates and proteins, are principal and essential components of the daily human diet. Fats introduced with the diet are largely constituted of mono-, di- or triglyceryl esters of fatty acids. Fatty acids can be divided, based on the structure of their hydrocarbon chain, into saturated and unsaturated fatty acids. Fats rich in saturated fatty acids can be found in food of animal origin (cream, butter, milk, meat etcetera) while unsaturated fatty acids are usually found in food of vegetable origin (oils, margarine, etcetera).

Fats provide the most concentrated source of energy in the diet (9 kcal per gram). Some fatty acids are essential in the production of hormone-like substances. Moreover, fats help the body adsorb and transport the fat-soluble vitamins A, D, E and K. Fats play also a very important role in the flavour of food. Not only fats add some flavour directly to food, but they also blend flavours which are soluble in fat. Furthermore the (partial) decomposition of some types of fat during cooking is also responsible for flavour development in food.

However several health organisations warn the public against an excessive ingestion of fat with the diet. High intake of dietary fat is associated with an increased risk for obesity, some types of cancer and coronary hearth disease. These latter health problems are growing in the western society where a wealthier and more hectic lifestyle of the population is leading to an increased consumption of processed food. Processed food is often rich in fat.

A new trend in the food industry is therefore the introduction in the market of fat-free food, low fat food and reduced fat food. The US Food and Drug Administration (FDA) has regulated the use of such nutrient content labels in food in the US (US Food and Drug Administration, Center for Food Safety & Applied Nutrition, “A Food Labeling Guide”, September 1994 (Editorial revisions June 1999)). Accordingly, nutrient content labels relative to fat content in food are described in the US Code of Federal Regulation, Title 21, Vol. 2, Part 101 “Food labelling”, Sec. 101.62(b) (revised as of Apr. 1, 2002) (abbreviated as 21 CFR 101.62(b)).

Fat in the context of the present invention means “total fat”, i.e. fat containing both saturated and unsaturated fatty acids. The fat content in the food is determined by measuring the amount of fatty acids and expressing this amount as amount of triglycerides of these fatty acids. It is known to those skilled in the art how to measure this amount in food.

Given the importance of fat in determining the taste of food, a clear disadvantage of food with a reduced amount of fat is that the latter lacks the richness of flavour of the corresponding full-fat food.

In “Food Engineering, 1989, Vol. 61, no. 9, page 46, 48” it is described the use of an autolysed yeast product to improve the taste of reduced fat sausages.

DE 199 22 362 describes the use of a seasoning mixture comprising a beer yeast. autolysate to improve the taste of meat, in particular sausages, and cheese with reduced fat.

A problem related to the use of yeast autolysates in reduced fat food is that the fat note in the taste and/or aroma and/or mouthfeel of the food is not sufficiently improved and that a bouillon-like, brothy taste is added to the food.

A goal of the present invention is to offer a solution to this problem.

### DESCRIPTION OF THE INVENTION

In a first aspect, the present invention provides a method for improving the fat note in the taste and/or in the aroma and/or in the mouthfeel of a food with a reduced amount of fat by addition to the food of a yeast extract comprising free amino acids and at least 8% w/w of 5′-ribonucleotides.

Yeast extract is defined as a composition comprising the water-soluble components extracted from yeast cells. In general, yeast extracts comprise amino acids, proteins, peptides, vitamins, carbohydrates and salts like phosphates. Yeast extracts may as well comprise 5′-ribonucleotides.

Autolytic yeast extracts are concentrates of the soluble materials obtained from yeast after disruption of the cells and digestion (lysis) of the polymeric yeast material. The active yeast enzymes released in the medium after cell disruption, are responsible for the lysis. Generally these types of yeast extracts do not comprise 5′-ribonucleotides because during the autolytic process the native RNA is decomposed or modified in a form which is not or almost not degradable into 5′-ribonucleotides. These types of yeast extract, which are rich in amino acids, are used in the food industry as basic taste providers. The amino acids present in the yeast extract add a bouillon-like, brothy taste to the food.

Hydrolytic yeast extracts, on the other hand, are concentrates of the soluble materials obtained from yeast after disruption of the cells, digestion (lysis) and addition of proteases and/or peptidases and especially nucleases to the yeast suspension during. lysis. The native yeast enzymes are inactivated prior to the lysis. During this process, 5′-ribonucleotides of guanine (5′-guanine mono phosphate; 5′-GMP), uracil (5′-uracil mono phosphate; 5′-UMP), cytosine (5′-cytosine mono phosphate; 5′-CMP) and adenine (5′-adenine mono phosphate; 5′-AMP) are formed. When adenylic deaminase is added to the mixture, 5′-AMP is transformed into 5′-inosine mono phosphate (5′-IMP). Hydrolytic yeast extracts are therefore rich in 5′-ribonucleotides, especially rich in 5′-GMP and 5′-IMP.

Often autolytic and hydrolytic yeast extracts are also rich in mono sodium glutamate (MSG). 5′-IMP, 5′-GMP and MSG are known for their flavour enhancing properties. They are capable of enhancing the savoury and delicious taste in certain types of food. This phenomenon is described as ‘mouthfeel’ or umami. The natural 5′-ribonucleotides of hydrolytic yeast extracts demonstrate a synergistic effect with the glutamate present in the extract as well as in the food substrate to which the yeast extract is added. Yeast extracts rich in 5′-ribonucleotides and, optionally, rich in MSG, are usually added to soups, sauces, marinades, meat, vegetables, gravies and flavour seasonings.

Ribonucleotides as for example 5′-GMP and 5′-IMP are also usable as isolated compounds, i.e. not in the form of a yeast extract, in the above-mentioned applications. However the latter has the disadvantage that the ribonucleotides need to be chemically isolated from their RNA sources.

In the context of the present invention “improve the fat note in the taste and/or in the aroma and/or in the mouthfeel of food with a reduced amount of fat” refers to the capacity of a yeast extract when added to said food to enhance the specific fat note in. the taste and/or in the aroma and/or in the mouthfeel of the food with a reduced amount of fat making it more similar to the taste and/or aroma and/or mouthfeel of the corresponding full-fat food, preferably by providing only a minimal taste or specific note of the yeast extract itself, more preferably by not providing any taste or specific note of the yeast extract itself. With taste or specific note of the yeast extract itself is meant any bouillon-like, brothy taste or any after taste associated with yeast (yeasty taste and/or odour).

In the context of the present invention the word “food” means either a nutriment in solid form or a beverage.

Throughout this specification the wording “food with a reduced amount of fat” will be used indicating thereby a food which comprises at least 25% w/w less fat per fixed amount of food than the corresponding full-fat food. Said food with a reduced amount of fat may comprise at least 50% w/w less fat than the corresponding full-fat food. The food with a reduced amount of fat may also comprise as less as 95 % w/w, or approximately as less as 100% w/w less fat than the corresponding full-fat food.

Generally the full-fat food comprises between 1-100% w/w of fat and/or at least 10-100% of the caloric value of this food is coming from fat.

The full fat food will generally be a food which has not been altered, processed or formulated in order to reduce its fat content. The corresponding full fat food is typically a food of the same type as the reduced fat food (e.g. spread cheese for spread cheese with a reduced amount of fat). The amount of fat in the corresponding full-fat food is typically the amount of fat which in average is present in that type of food and which is given in recognised food databases and/or in handbooks reporting nutritional information for generic and/or brand name food. Often the-full fat food is the regular product (i.e. the product not indicating that the fat content in the food is reduced) which is sold by the same manufacturer selling the reduced fat food or which is sold under the same trade name as the reduced fat food. By corresponding full-fat food is preferably meant an “appropriate reference food” as defined in the above-mentioned 21 CFR 101.62(b) and more specifically as defined in 21 CFR 101.13 (j)(1)(i)(B), and 101.13(j)(1)(ii)(A)(B). In the present case, the “appropriate reference food” and the food with a reduced amount of fat may as well be a “low fat food” (as defined hereafter). The “appropriate reference food” may not be a “fat free food” (i.e., a food with approximately 0% of fat or as defined in the above-mentioned FDA Food Labelling guide and in 21 CFR 101.62(b)(1)). Several types of vegetables or fruit or juices thereof, carbonated drinks and alcoholic drinks are fat free.

More preferably the “appropriate reference food” is not a low fat food. A definition of low fat food is given in the above-mentioned FDA Food Labelling guide and in 21 CFR 101.62(b)(2). Accordingly a “low fat food” is a food containing 3 g or less of fat per reference amount customarily consumed when the latter is greater than 30 g or greater than 2 tablespoons, or a food containing 3 g or less of fat per reference amount customarily consumed and per 50 g of food when the latter is 30 g or less or 2 tablespoons or less. In this context reference amount means the amount of that specific food category which is customarily consumed per eating occasion. A table indicating the reference amount customarily consumed per specific food category is given. in the above-mentioned 21 CFR 101.1 2(b).

The food with a reduced amount of fat will typically contain an amount of fat between ˜0-75% w/w, depending on the type of food.

Generally the food with a reduced amount of fat is a processed food. It may be derived from the corresponding full-fat food by any processing, alteration, formulation or reformulation which leads to the lowering of the fat comprised therein and/or replacement of said fat with a fat replacer. Said processes and said fat replacers are known in the art. Alternatively, the food with a reduced amount of fat is not derived from the corresponding full-fat food, but it is processed from several starting ingredients including fat and/or fat replacers in order to minimise the fat content in the food.

The yeast extracts used in the invention are generally obtained from yeast strains with a high RNA content. By this way a high amount of 5′-ribonucleotides is generated during the hydrolytic process. Generally yeast strains are used belonging to the genera Saccharomyces, Kluyveromyces and Candida. Yeast strains belonging to the genus Saccharomyces, for example to the species Saccharomyces cerevisiae, are preferred. Yeast extracts derived from strains belonging to the genus Candida, for example to Candida utilis, or Torula yeast, may be characterized by an aftertaste or a sweet taste. Preferably, the yeast is chosen such that the yeast extract prepared from the yeast confers to the food only a minimal taste or specific note typical of the yeast extract itself, preferably said taste or specific note is absent.

In the context of the invention the term “5′-ribonucleotides” means 5′-ribonucleotides comprising at least 5′-GMP and optionally 5′-IMP, more preferably comprising at least both 5′-GMP and 5′-IMP, typically also comprising 5′-CMP, 5′-UMP and optionally 5′-AMP. Typically the “5′-ribonucleotides” will be a mixture of 5′-GMP, 5′-CMP, 5′-UMP and further 5′-AMP and/or 5′-IMP, wherein the 5′-IMP is obtained by conversion of 5′-AMP into 5′-IMP. The “5′-ribonucleotides” are generally obtained by hydrolysis of the RNA present in the yeast during the yeast extract preparation and optionally transformation of 5′-AMP into 5′-IMP as indicated above. The term 5′-ribonucleotides is intended to refer to either the free 5′-ribonucleotides or salts thereof. All weight percentages of 5′-ribonucleotide in the yeast extract are calculated based on the corresponding disodium salt heptahydrate (2Na.7Aq). The amount of 5′-ribonucleotides in the yeast extract is measured using standard HPLC methods known to those skilled in the art.

All weight percentages in the yeast extract are based on sodium chloride-free yeast extract dry matter with the exception of the weight percentage of sodium chloride in the yeast extract which is based on yeast extract dry matter. Sodium chloride-free does not mean that the yeast extract does not contain sodium chloride. It means that sodium chloride is excluded from the yeast extract for the calculation of the weight percentage. The latter calculation and the measurement of sodium chloride in the yeast extract can be. performed by methods known to those skilled in the art.

The content of 5′-ribonucleotides in the yeast extract is important for improving the taste and/or aroma and/or mouthfeel of a food with a reduced amount of fat.

The yeast extract used in the method of the invention preferably comprises 5′-ribonucleotides in a range of between 10 and 50% w/w, preferably between 10 and 40% w/w, more preferably between 10 and 30% w/w.

The ribonucleotides in the yeast extract used in the method of the invention comprise 5′-GMP and optionally 5′-IMP. The presence of 5′-GMP and optionally 5′-IMP in the yeast extract has a beneficial effect in improving the fat note in the taste and/or in the aroma and/or the fat note of the food with reduced amount of fat wherein it is added.

Therefore in a preferred embodiment of the invention, the yeast extract comprises 5′-GMP and optionally 5′-IMP in a total amount of at least 4% w/w, preferably between 5 and 25% w/w, more preferably between 5 and 20% w/w, most preferably between 5 and 15% w/w. Preferably the yeast extract used in the method of the invention comprises both 5′-GMP and 5′-IMP.

Preferably, the yeast extract used in the invention has a low content of free amino acids and/or a low degree of protein hydrolysis. A low content of free amino acids and/or a low degree of protein hydrolysis in the yeast extract has a positive effect on the taste and/or aroma and/or mouthfeel of the food with a reduced amount of fat wherein said yeast extract is added. The degree of protein hydrolysis in the yeast extract is measured as the percentage of nitrogen in the yeast extract belonging to primary amino groups as compared to the percentage of nitrogen, as determined by the Kjeldahl nitrogen method.

The yeast extract used in the method of the invention preferably has a degree of protein hydrolysis of at most 50%, preferably between 5 and 45%, more preferably between 10 and 45%, even more preferably between 20 and 45%, most preferably 30 and 45%.

We have surprisingly found that a yeast extract having a ratio of at most 3.5 between the percentage (w/w) of free amino acids and the percentage (w/w) of the total. amount of 5′-GMP and 5′-IMP provides an optimal improving effect on the fat note in the taste and/or in the aroma and/or in the mouthfeel of the food with a reduced amount of fat to which the yeast extract is added. Said yeast extract provides no or minimal bouillon-like, brothy taste or after taste associated with yeast (yeasty taste and/or odour).

Therefore in a preferred embodiment of the invention a yeast extract is used wherein the ratio between the percentage (w/w) of free amino acid and the percentage (w/w) of the total amount of 5′-GMP and 5′IMP in the yeast extract is at most 3.5, preferably at most 3, even more preferably at most 2.5 and most preferably at most 2. The lower limit of this range is less critical typically being at least 0.1, preferably at least 0.2, more preferably at least 0.5 and most preferably at least 1.

The amount of amino acids in the yeast extract is measured using standard HPLC methods known to those skilled in the art.

The “percentage (w/w) of protein” in the yeast extract, is calculated by multiplying by 6.25 the percentage of the total nitrogen as measured with the Kjeldahl method in a determined amount of yeast extract. This factor 6.25 is the generally accepted conversion factor from nitrogen to protein.

Surprisingly it has been found that the ratio between the percentage (w/w) of protein in the yeast extract and the percentage (w/w) of the total amount of 5′-GMP and 5′-IMP in the yeast extract is also important in determining the improving effect of the yeast extract on the taste and/or aroma and/or mouthfeel of a food with a reduced amount of fat.

When the above-mentioned ratio is lower, the taste and/or aroma and/or mouthfeel of the food is most improved because the contribution to the taste and/or aroma and/or mouthfeel of the food given by the yeast extract itself is the smallest.

Therefore in a preferred embodiment of the invention the ratio between the percentage (w/w) of protein in the yeast extract and the percentage (w/w) of the amount of 5′-GMP and 5′-IMP in the yeast extract is at most 12, preferably at most 8, more preferably at most 6.5. Generally this ratio is at least 0.1, typically at least 0.5.

The yeast extracts used in the method according to the invention are preferably, characterised by a low sodium chloride content. The latter is advantageous because a high content of sodium chloride in the diet is detrimental to health. The amount of sodium chloride in the yeast extract is preferably at most 8% w/w based on yeast extract dry matter, preferably at most 7% w/w, preferably at most 5% w/w, more preferably at most 3% w/w, even more preferably at most 1.5% w/w, most preferably at most 1%. The lower limit for the above-mentioned range can be as low as 0%.

The yeast extract used in the method of the invention may further comprise mono sodium glutamate (MSG).

Yeast extracts, which are particularly preferred in the method of the invention comprise an amount of ribonucleotides of 10-30% w/w.

Preferably said yeast extracts comprise a total amount of 5′-GMP and 5′-IMP of 5-15% w/w.

Preferably said yeast extracts have a ratio between the percentage (w/w) of free amino acids and the percentage (w/w) of the total amount of 5′-GMP and 5′-IMP of at most 2 and generally at least 1.

Preferably said yeast extracts have a ratio between the percentage (w/w) of protein in the yeast extract and the percentage (w/w) of the total amount of 5′-GMP and 5′-IMP in the yeast extract of at most 12.

Yeast extracts belonging to the above-mentioned category are for example the yeast extracts Maxarome Plus LS® (DSM-Delft-The Netherlands) and Maxarome Premium LS® (DSM-Delft-The Netherlands).

The amount of yeast extract used in the method of the invention will largely depend on the food application and on the amount of 5′-ribonucleotides in the yeast extract. This amount may be determined by those skilled in the art. Generally an amount of yeast extract will be used between 0.0001% w/w and 5% w/w relative to the food. Preferably an amount of yeast extract between 0.001-1% w/w is used, more preferably between 0.001-0.1% w/w, most preferably between 0.001-0.01% w/w.

Another goal of the invention is to provide food with a reduced amount of fat wherein the fat note in the taste and/or in the aroma and/or in the mouthfeel is improved.

Therefore, in a second aspect the invention provides a food with a reduced amount of fat with an improved fat note in the taste and/or in the aroma and/or in the mouthfeel obtainable by adding to a food with a reduced amount of fat a yeast extract as described in the first aspect of the invention.

The present invention finds very suitable application in food with a reduced amount of fat which belongs to the category of dairy products, bakery products, salad. dressings, confectionary products or in food with a reduced amount of fat which is derived from fat or oil-rich products.

Examples of diary products with a reduced amount of fat where the invention is applicable are milk, flavoured milk like for example chocolate milk, yoghurt, cream, sour cream, sour milk, cheese, ice cream, frozen dessert.

Examples of products derived from fat or oil-rich food are butter, margarine, mayonnaise with a reduced amount of fat.

Examples of confectionary product are chocolate, candies with a reduced amount of fat.

The invention will now be illustrated by some examples, which however are not intended to be limiting.

### EXAMPLES

In the following examples several yeast extracts are tested in food with a reduced amount of fat. The composition of these yeast extracts is given in the following table.

### Composition of Yeast Extracts Used in the Experiments

| Type yeast | 5′- | | | | | Protein | Free aa/ | Protein/ |
|---|---|---|---|---|---|---|---|---|
| extract | ribo¹ | G + I² | Free aa³ | Protein⁴ | NaCl⁵ | Hydrol.⁶ | (G + I)⁷ | (G + I)⁸ |
| Maxarome | 13% | 6.5% | 11.7% | 73% | 0.8% | 34% | 1.8 | 11.2 |
| Plus ® | | | | | | | | |
| Maxarome | 24% | 12% | 17.7% | 59% | 0.8% | 43% | 1.48 | 4.92 |
| Premium ® | | | | | | | | |
| KRIT ® | 8.6% | 4.3% | 16.3% | 71% | 12% | 38% | 3.8 | 16.51 |
| KAT ® | ˜0 | ˜0 | 44.3% | 75% | 1% | 57% | — | — |

¹% (w/w) 5′-ribonucleotides based on sodium chloride free yeast extract dry matter
²% (w/w) 5′-GMP + 5′-IMP based on sodium chloride free yeast extract dry matter
³% (w/w) free amino acids based on sodium chloride free yeast extract dry matter
⁴% (w/w) protein based on sodium chloride free yeast extract dry matter
⁵% (w/w) sodium chloride based on yeast extract dry matter
⁶% protein hydrolysis
⁷ratio between ³ and ²
⁸ratio between ⁴ and ²

### Example 1

In this example the effects of the addition of yeast extracts on a chocolate milk with a reduced amount of fat are compared. Said yeast extracts comprise at least 8% w/w of 5′-ribonucleotides, 5′-IMP+5′-GMP and free amino acid, and have different ratios between the percentage (w/w) of free amino acids and the percentage (w/w) of the total amount of 5′-GMP and 5′-IMP, and between the percentage (w/w) of protein in the yeast extract and the percentage (w/w) of the total amount of 5′-GMP and 5′-IMP, respectively. A yeast extract not comprising 5′-ribonucleotides is also tested.

Ingredients
Maxarome Plus LS® powder (DSM-Delft—The Netherlands)
Maxarome Premium LS® powder (DSM-Delft—The Netherlands)
KRIT® (Ohly, Marl, Germany)
KAT® (Ohly, Marl, Germany)
Halfvolle Chocomel® (Nutricia drinks, Zoetermeer—The Netherlands) (chocolate milk drink with reduced amount of fat, fat 1.8 g/100 ml)
Chocomel® (Nutricia drinks, Zoetermeer—The Netherlands) (chocolate milk drink with full-fat content, 2.7 g/100 ml fat, total caloric value: 90 kcal)

The samples reported in table 1 were prepared by adding the proper amount of a concentrated solution of yeast extract in water to 100 g of chocolate milk with reduced amount of fat. The same dilution was realised in all samples by addition of water when necessary. Blank 1 (chocolate milk with reduced amount of fat) and blank 2 (chocolate milk with full fat content), respectively, where prepared by addition of water to 100 g of sample in order to obtain the same dilution as in the samples comprising yeast extract.

The amount of 5′-ribonucleotides in the samples comprising Maxarome Plus®, Maxarome Premium® and KRIT® was substantially the same.

A panel of 4 experts in the tasting of foodstuff tested the blank samples and those containing the yeast extracts.

The results are reported in table 1.

TABLE 1

| | | Improvement of | | |
|---|---|---|---|---|
| | | fat note in | | |
| | % w/w | taste, aroma, | Similarity | |
| | yeast | mouthfeel in | with taste, | |
| | extract | respect of | aroma, mouth- | |
| Type yeast | relative | reduced fat | feel of full | Yeasty |
| extract | to food | blank 1 | fat blank 2 | taste |
| Maxarome | 0.0132 | ++ | (+)++ | Absent |
| Plus ® | | | | |
| Maxarome | 0.0072 | +++ | +++ | Absent |
| Premium ® | | | | |
| KRIT ® | 0.02 | + | + | Modest |
| KAT ® | 0.02 | − | − | Moderate |

*With yeasty taste it is herewith intended the contribution of the yeast extract own taste and/or note to the overall taste of the food.
The number of “+” in the table indicates the degree of improvement of taste in respect with blank 1 or the degree of similarity with taste of blank 2. The sign “−” in the 3^{rd} or 4^{th} column indicates that the yeast extract has no effect

Table 1 shows that the best results in this application regarding improvement of fat note in the taste and/or in the aroma and/or in the mouthfeel in respect of the chocolate milk with reduced amount of fat and similarity with the taste and/or aroma and/or mouthfeel of the corresponding full-fat product are obtained with Maxarome Premium®, followed by Maxarome Plus® and KRIT®. The contribution of the yeast extract own taste and/or note to the overall taste of the food was absent in Maxarome Premium® and in Maxarome Plus®. A modest bouillon-like/yeasty taste could be noticed for KRIT®, and a more intense bouillon-like/yeasty taste could be noticed for KAT®. KAT® had no effect on improvement of taste of the corresponding sample.

### Example 2

In this experiment the yeast extracts used in example 1 were tested on a flavoured milk drink with full-fat and with reduced amount of fat, respectively.

Ingredients
Yeast extracts as in example 1
Milk & Fruit® light, orange taste, (Friesche vlag-Ede—The Netherlands) (flavoured milk with a reduced amount of fat, fat ˜0 g/100 ml)
Milk & Fruit®, orange taste, (Friesche vlag—Ede-The Netherlands) (full-fat flavoured milk, fat 1 g/100 ml, total caloric value: 70 kcal)
The amount of 5′-ribonucleotides in the samples comprising Maxarome Plus®, Maxarome Premium® and KRIT® was substantially the same.

In a way analogous to that described in experiment 1, samples comprising the yeast extracts of example 1 and the blank samples (Blank 1: Milk & Fruit®, light; Blank 2: Milk & Fruit® full-fat) were prepared. The concentrations of the samples are reported in table 2.

A panel of 4 experts in the tasting of foodstuff tested the blank samples and those containing the yeast extracts. The results are reported in table 2.

TABLE 2

| | | Improvement of | | |
|---|---|---|---|---|
| | | fat note in | | |
| | % w/w | taste, aroma, | Similarity | |
| | yeast | mouthfeel in | with taste, | |
| | extract | respect of | aroma, mouth- | |
| Type yeast | relative | reduced fat | feel of full | Yeasty |
| extract | to food | blank 1 | fat blank 2 | taste |
| Maxarome | 0.0132 | ++ | ++ | Almost |
| Plus ® | | | | absent |
| Maxarome | 0.0072 | +++ | +++ | Absent |
| Premium ® | | | | |
| KRIT ® | 0.02 | + | + | Modest |
| KAT ® | 0.02 | − | − | Moderate |

Legend like in Table 1

Likewise in example 1 and as reported in table 2, the fat note in the taste and/or in the aroma and/or in the mouthfeel in the sample comprising Maxarome Premiums was the most improved in respect with the reduced fat Blank 1 and its taste and/or aroma and/or mouthfeel was the most similar to that of the full fat blank 2, followed by the samples comprising Maxarome Plus® and KRIT®, in this order. The contribution of the yeast extract own taste and/or note to the overall taste and/or aroma and/or mouthfeel of the food was absent in Maxarome Premium® and almost absent in Maxarome Plus®. A slight yeasty taste could be noticed for KRIT, and a more intense yeasty taste could be noticed for KAT®. KAT® had no effect on improvement of taste of the corresponding sample.

### Example 3

In this experiment the yeast extracts Maxarome Plus LS®, Maxarome Premium LS® and KAT® used in example 1 were tested on mayonnaise and on spread cheese with full-fat and on mayonnaise and on spread cheese with reduced amount of fat, respectively.

Ingredients
Maxarome Plus LS®, Maxarome Premium LS® and KAT® as in example 1.
Calvé Mayonaise® (Unilever Bestfoods Nederland/Calvé Rotterdam—The Netherlands) (Full-fat mayonnaise, analysis of product: proteins 1g/100g, carbohydrates: 5 g/100 g of which are sugars 4 g/100 g, fat 71 g/100 g)
Calvé Halfvolle Mayo® (Unilever Bestfoods Nederland/Calvé Rotterdam—The Netherlands) (mayonnaise with a reduced amount of fat, analysis of product: proteins 0.6 g/100 g, carbohydrates: 11 g/100 g of which are sugars 7.5 g/100 g, fat 36 g/100 g)
Goudkuipje® (Koninklijke Eru Kaasfabriek B.V., Woerden—The Netherlands) (full-fat spread cheese, analysis of product: proteins 12 g/100 g, carbohydrates: 2 g/100 g, fat 21 g/100 g)
Slimkuipje® (Koninklijke Eru Kaasfabriek B.V., Woerden—The Netherlands) (spread cheese with a reduced amount of fat, analysis of product: proteins 14 g/100 g, carbohydrates: 4 g/100 g, fat 5 g/100 g)

The amount of 5′-ribonucleotides in the samples comprising Maxarome Plus®, and Maxarome Premium® was substantially the same.

Samples comprising the yeast extracts mentioned above were prepared by adding the yeast extracts as such directly to the food with a reduced amount of fat in order to obtain the desired concentration. Blank samples were the full-fat food (blank 2) and the food with a reduced amount of fat (blank 1). The concentrations of the samples are reported in table 3 (mayonnaise) and in table 4 (spread cheese) respectively.

A panel of 4 experts in the tasting of foodstuff tested the blank samples and those containing the yeast extracts. The results thereof are also reported in table 3 and 4.

TABLE 3

| | | | Similarity | |
|---|---|---|---|---|
| | | Improvement of fat | with taste, | |
| | % w/w | note in taste, aroma, | aroma, mouth- | |
| | yeast | mouthfeel in respect | feel of full | |
| | extract | of reduced fat blank | fat blank 2 | |
| Type yeast | relative | 1 (Calvé Halfvolle | (Calvé | Yeasty |
| extract | to food | mayo ®) | mayonaise ®) | taste |
| Maxarome | 0.21 | ++ | (+)++ | Absent |
| Plus ® | | | | |
| Maxarome | 0.1 | +++ | +++ | Absent |
| Premium ® | | | | |
| KAT ® | 1 | − | − | Strong |

Legend like in Table 1

TABLE 4

| | | | Similarity | |
|---|---|---|---|---|
| | % w/w | Improvement of fat | with taste, | |
| | yeast | note in taste, aroma, | aroma, mouth- | |
| | extract | mouthfeel in respect | feel of full | |
| Type yeast | relative | of reduced fat blank | fat blank 2 | Yeasty |
| extract | to food | 1 (Slimkuipje ®) | (Goudkuipje ®) | taste |
| Maxarome | 0.21 | ++ | (+)++ | Absent |
| Plus ® | | | | |
| Maxarome | 0.1 | +++ | +++ | Absent |
| Premium ® | | | | |
| KAT ® | 1 | − | − | Strong |

Legend like in Table 1

Likewise in example 1, the fat note in the taste and/or in the aroma and/or in the mouthfeel in the samples comprising Maxarome Premium LS® were the most improved in respect with the reduced fat Blank 1 and its taste and/or aroma and/or mouthfeel was the most similar to that of the full fat blank 2, followed by the samples comprising Maxarome Plus®. The contribution of the yeast extract own taste and/or note to the. overall taste and/or aroma and/or mouthfeel of the food was absent in Maxarome Premium® and in Maxarome Plus®. A rather intense yeasty taste could be noticed for KAT. KAT had no effect on improvement of taste of the corresponding sample.

### Example 4

In this experiment the effect of the concentration of Maxarome Premiums yeast extract on the flavoured milk with a reduced amount of fat of example 2 was tested.

In a way analogous to that described in example 1, samples comprising different concentrations of Maxarome Premium® in Milk & Fruit® light, were prepared and tested in comparison with the blank samples 1 and 2 of example 2, by a panel of 4 experts in the tasting of foodstuff. The results are reported in table 5.

It was observed that in sample (1)-(3) the taste and/or aroma and/or mouthfeel of the flavoured milk drink comprising the yeast extract is improved in respect with the reduced fat blank 1 and getting closer to the taste of the full fat blank 2. The better taste improvement is observed with sample (3). *Sample (4) has a sweet (after)taste and the effect of the yeast extract on the taste is a little overdone, the overall taste being less balanced. *Sample (5) has a taste which is off-balanced, indicating that the dosage of the yeast extract in this sample is too high.

TABLE 5

| | Yeast extract | Improvement of fat | Similarity with |
|---|---|---|---|
| | relative | note in taste, aroma, | taste, aroma, |
| | to food | mouthfeel in respect | mouthfeel of |
| Sample | (% w/w) | of reduced fat blank 1 | full fat blank 2 |
| 1 | 0.0018 | + | + |
| 2 | 0.0036 | ++ | ++ |
| 3 | 0.00722 | +++ | +++ |
| 4 | 0.0144 | * | * |
| 5 | 0.02 | * | * |

Legend like in Table 1 except for:
*See text.

This example also shows that the skilled person can easily determine the effective amount of yeast extract needed according to the present invention in a flavored drink with a reduced amount of fat in this case or for a food product with a reduced amount of fat in general.

1. Method for improving the fat note in the taste and/or in the aroma and/or in the mouthfeel of a food with a reduced amount of fat by addition to the food of a yeast extract comprising free amino acids and at least 8% w/w of 5′-ribonucleotides.

2. Method according to claim 1 wherein the yeast extract comprises 5′-ribonucleotides in a range of between 10 and 50% w/w, preferably between 10 and 40% w/w, more preferably between 10 and 30% w/w.

3. Method according claim 1 wherein the yeast extract comprises 5′-GMP and optionally 5′-IMP in a total amount of at least 4% w/w, preferably between 5 and 25% w/w, more preferably between 5 and 20% w/w, most preferably between 5 and 15% w/w.

4. Method according to claim 1 wherein the degree of protein hydrolysis in the yeast extract is at most 50%, preferably between 5 and 45%, more preferably between 10 and 45%, even more preferably between 20 and 45%, and most preferably between 30 and 45%.

5. Method according to claim 1, wherein the ratio between the percentage (w/w) of free amino acids and the percentage (w/w) of the total amount of 5′-GMP and 5′-IMP in the yeast extract is at most 3.5, preferably at most 3, more preferably at most 2.5 and most preferably at most 2.

6. Method according to claim 1 wherein the ratio between the percentage (w/w) of protein in the yeast extract and the percentage (w/w) of the total amount of 5′-GMP and 5′-IMP in the yeast extract is at most 12, preferably at most 8, more preferably at most 6.5.

7. Method according to claim 1 wherein the yeast extract comprises an amount of sodium chloride of at most 8% w/w based on yeast extract dry matter.

8. Food with a reduced amount of fat with an improved fat note in the taste and/or in the aroma and/or in the mouthfeel obtainable by adding to a food with a reduced amount of fat a yeast extract comprising free amino acids and at least 8% w/w of 5′-ribonucleotides.

9. Food according to claim 8, which is a dairy product.

10. Food according to claim 8, which is a bakery product.

11. Food according to claim 8, which is derived from a fat or oil-product.
